(19) United States
(12) Patent Application Publication
(10) Pub. No.: US 2005/0136154 A1
(43) Pub. Date: Jun. 23, 2005

(54) Method of producing, and composition of, cereal products or food particulates with zero net glycemic carbohydrates

(76) Inventors: Travis Malo, Fairmont, MN (US); Hal Volkmann, Mankato, MN (US); David Staley, Fairmont, MN (US)

Correspondence Address: CHOATE, HALL & STEWART LLP, EXCHANGE PLACE, 53 STATE STREET, BOSTON, MA, 02109, US

(21) Appl. No.: 10/988,097

(22) Filed: Nov. 12, 2004

Related U.S. Application Data
(60) Provisional application No. 60/519,725, filed on Nov. 13, 2003.

(51) Int. Cl. A23L 1/30

(52) U.S. Cl. 426/72

(57) ABSTRACT

The present invention is directed towards a method of producing a cereal product or food particulate with zero net glycemic carbohydrates. In one aspect, the product or particulate has a defined cell structure and cell strength. In another aspect, the method comprises preparing, cooking, expanding, cutting and drying a protein blend.

### PRIORITY INFORMATION

This application claims priority to U.S. Provisional Patent Application No. 60/519,725 filed on Nov. 13, 2003.

### FIELD OF INVENTION

The present invention is directed towards a method of producing, and composition of, cereal products or food particulates used in or added to health bars, cereals, pie crusts, desserts, doughs or bread extenders and other food products which contain little or no glycemic carbohydrates (carbohydrates that generate little insulin response).

### BACKGROUND OF INVENTION

Obesity causes cancer, diabetes, depression, gallbladder disease, gout, heart attacks, heart disease, hypertension, lower back pain, osteoarthritis, sleep apnea, stroke and other physical and mental complications. In today's health conscious society, people continue to search for a solution to obesity.

The macronutrients people eat are of three types: carbohydrates, proteins and fats. All of these macronutrients provide calories but the amount of calories and how they are digested and absorbed are quite different. Both carbohydrates and proteins have about 4 calories per gram but fats have 9 calories per gram. Carbohydrates are more easily digested and absorbed than proteins and fats and are absorbed at the slowest rate. There are two reasons for this: first, carbohydrates pass through the stomach very fast whereas proteins and fats delay the emptying of stomach contents into intestine, from where the foods are absorbed; second, the digestion process of carbohydrates is much simpler than for protein and fats which are broken down by very slow chemical reactions. As a result, carbohydrates have the highest glycemic index.

Carbohydrates stimulate the body to produce insulin hormone. Insulin controls the movement of sugar from food into the cells of the body where it is then either used for energy or stored as fat. Years of excessive insulin production (hyperinsulinemia) from eating high amounts of carbohydrates leads to a steady decrease in the sensitivity of cells to insulin which in turn leads to the body having to make more and more insulin to get the same job done. This is known as “insulin resistance” and if left untreated, can lead to high cholesterol, heart disease, obesity and type II diabetes. A side effect of insulin is that it also causes fat to be deposited. Furthermore, insulin stimulates the brain to produce hunger signals.

A healthy diet first begins by selecting foods that have a low glycemic index. Restricting one's consumption of high carbohydrate foods is the most effective way to control and cure insulin resistance and the host of disorders and health problems which typically accompany it. When one reduces their carbohydrate intake, insulin levels decrease and levels of glucagon increase. Glucagon is the hormone that causes body fat to be burned and cholesterol to be removed from deposits in the arteries. Therefore it is one aspect of the present invention to provide a method of producing, and composition of, cereal products or food particulates with zero net glycemic carbohydrates.

Most people who try dieting or taking some action to lose weight feel that they fight a losing battle with carbohydrates. More specifically, many report that many carbohydrates in the form of snacks and desserts such as cakes, pies, cookies, crackers, cereals, cereal bars or chips are impossible to remove or limit from their food intake because of their high satisfaction value, i.e. great taste, great texture, etc. Zero net carbohydrates are defined as total carbohydrates minus fiber and sugar alcohols or other carbohydrates that initiate little or no glycemic response. Most carbohydrate-like products on the market today contain approximately 15-85% carbohydrates. Currently there are no known methods in the prior art that produce a cooked, expanded cereal crisp product that has zero net carbohydrates. Furthermore, prior art was unable to produce a carbohydrate-like product with a defined expanded cell structure and robust durable texture. Therefore it is one aspect of the present invention to produce a cereal or particulate product used in, or added to, health bars, cereals, piecrusts, desserts, dough or bread extenders and other carbohydrate-like foods with zero net glycemic carbohydrates. It is another aspect of the present invention to produce such cereal or particulate product with a defined expanded cell structure and robust durable texture. It is yet another aspect of this invention to produce such products in a controllable process.

Those following a low carbohydrate diet replace carbohydrates with fats and proteins. A problem cited with low carbohydrate diets is that much calcium is lost. On low carbohydrate diets, people must limit their milk intake so they may receive even less dietary calcium than they would normally. One further aspect of the present invention is to produce a cereal or food particulate with calcium fortification and proteins derived from soy at levels above the minimum of 6.25 g/serving.

The expanded food particulate of the present invention is not limited to cereal applications but may also be added to low carbohydrate desserts, health bars, dough extenders, piecrusts and other food products.

### SUMMARY OF INVENTION

In one embodiment, the present invention relates to a method of producing a cereal product or food particulate with zero net glycemic carbohydrates and having defined cell structure and cell strength comprising preparing a protein blend by mixing 20-60% thin viscosity protein isolate, 20-60% thick protein viscosity protein isolate, 5-40% neutral protein isolate, and at least one process aid or product modifier, cooking the protein blend, expanding the protein blend, cutting the protein blend and drying the protein blend. In another embodiment, the present invention relates to a composition of cereal product or food particulate with zero net glycemic carbohydrates comprising 20-60% thin viscosity protein isolate, 20-60% thick protein viscosity protein isolate, 5-40% neutral protein isolate and at least one process aid or product modifier, wherein the 20-60% thin viscosity protein isolate, 20-60% thick protein viscosity protein isolate, 5-40% neutral protein isolate, and at least one process aid or product modifier is mixed, cooked, expanded, cut and dried.

### BRIEF DESCRIPTION OF THE DRAWINGS

FIG. 1 is a flow diagram of the zero net soy crisp extrusion process; and

FIG. 2 is a schematic drawing of the apparatus for producing a composition of cereal products or food particulates with zero net glycemic carbohydrates.

### DETAILED DESCRIPTION OF THE DRAWING

In one embodiment, the present invention relates to a method of producing a cereal product or food particulate with zero net glycemic carbohydrates and having defined cell structure and cell strength comprising preparing a protein blend by mixing 20-60% thin viscosity protein isolate, 20-60% thick protein viscosity protein isolate, 5-40% neutral protein isolate, and at least one process aid or product modifier, cooking the protein blend, expanding the protein blend, cutting the protein blend and drying the protein blend. “Zero net” is defined as a net carbohydrate value of less than three (3). In another embodiment, the protein blend has the approximate viscosity of a blend with 20-60% thin viscosity protein isolate, 20-60% thick protein viscosity protein isolate, 5-40% neutral protein isolate, and at least one process aid or product modifier. The protein blend of the present invention may be pre-prepared. In one aspect of the embodiments, the composition of cereal product or food particulate is prepared from a formulated blend of soy isolates. In another aspect, the composition contains a process aid or product modifier such as calcium, sodium bicarbonate, dicalcium phosphate or other pH adjusters and leavening agents. In yet another aspect, the shape and size of the composition may be customized.

In another embodiment, the present invention is an apparatus for producing cereal product or food particulates with zero net glycemic carbohydrates and having defined cell structure and cell strength. The apparatus may include a mixing device for preparing a protein blend, wherein the protein blend comprises 20-60% thin viscosity protein isolate, 20-60% thick protein viscosity protein isolate, 5-40% neutral protein isolate, and at least one process aid or product modifier, a cooking device for cooking the protein blend, an expanding device for expanding the protein blend, a cutting device for cutting the protein blend, and a dryer for drying the protein blend. In the alternative, the apparatus may cook, expand, cut and dry a pre-prepared protein blend having an approximate viscosity of a mixture comprising 20-60% thin viscosity protein isolate, 20-60% thick protein viscosity protein isolate, 5-40% neutral protein isolate, and at least one process aid or product modifier.

In yet another embodiment, the present invention is a composition of cereal product or food particulates with zero net glycemic carbohydrates and having defined cell structure and cell strength comprising a protein blend of, or having the approximate viscosity of a mixture comprising, 20-60% thin viscosity protein isolate, 20-60% thick protein viscosity protein isolate, 5-40% neutral protein isolate; and at least one process aid or product modifier. In other embodiments, the protein blend is cooked, expanded, cut and dried according to the methods of the present invention.

Protein/Isolate Blends

In one embodiment, the protein portion of the cereal product or food particulate composition of the present invention is comprised of, but is not limited to, soy isolates. In one aspect, the blend of isolates, having various viscosities, is formulated to obtain a specific cell texture. The texture may be measured on a texture analyzer. In another aspect, the blend of isolates account for approximately 90-100% of the protein blend. In another embodiment, the composition includes process aids or product modifying agents. These product modifying agents allow for conditioning, leavening, pH adjustment and cell definition. In one aspect of this embodiment, the product modifying agents account for approximately 0-10% of the protein blend.

In another embodiment, the viscosity of at least one isolate promotes machineability of the composition. In such embodiment, at least one isolate is less viscous than at least one other isolate and therefore allows cell formation. A viscous protein and a non-viscous protein are blended together to create an ideal characteristic in the end composition. In another embodiment, the viscosity of at least one isolate is thick and promotes cell strength and uniform size. In one aspect, the thick isolates and thin isolates are combined to produce a composition with numerous cells and structural integrity.

In yet another embodiment, a protein source is added for flavor enhancement. This protein source further reduces the “bitter bean” note associated with thin viscosity isolates or proteins.

Process Aids/Product Modifying Agents

Process aids or product modifying agents are ingredients comprised of, but are not limited to, calcium carbonate, dicalcium phosphate, sodium bicarbonate, fiber, and mixtures thereof. In one aspect, these ingredients may form approximately 0-40% of the composition. Process aids or product modifying agents may be used alone or in concert with each other to further enhance cell formation and expansion.

Methodology

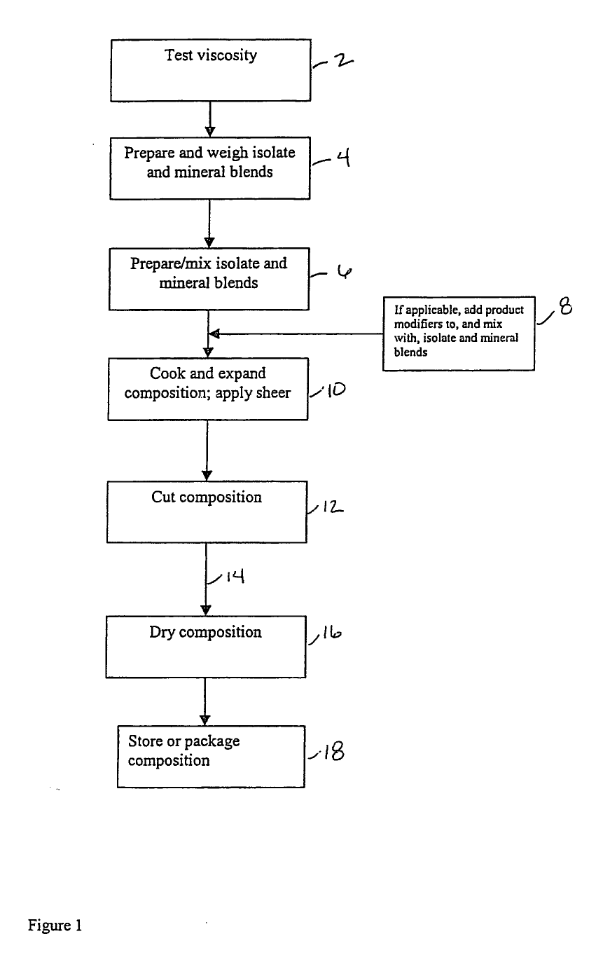

The process for producing a cereal or food particulate with zero net glycemic carbohydrates is shown in FIG. 1 and begins by testing 2 the viscosity of the thin viscous protein sources in the following manner:

First, 300 ml of room temperature (approximately 75° Fahrenheit) deionized water is mixed with 60 grams of protein isolate. In one aspect, 100 ml of deionized water is measured using a 100 ml graduated cylinder and added to a mixer bowl. This is repeated until 300 ml is added to the mixer bowl. Then 60 g of isolate blend is added directly on top of the water in the mixing bowl.

Next, the water and isolate blend is mixed at a low speed using a paddle mixer for approximately 10 minutes, stopping after 2 minutes to scrape down the sides of the bowl. In one aspect, a Hobart Kitchen Aide Mixer is used with the mixer starting at a setting of one (1). After 2 minutes, the mixer is stopped and the paddle is raised to allow for scraping the sides of the bowl. Any loose deposit should be scraped back down into the mixing bowl. Mixing should resume for approximately 8 minutes.

After a total of 10 minutes of mixing, the mixture is poured into a 250 ml beaker. Timer #1 is started and will run continuously through the rest of composition preparation and reading of viscosities. The sample sits undisturbed for approximately 1 minute. At 1 minute, foam is removed by aspirating, spooning or pipeting the surface down to the 200 ml level.

At 2 minutes, the sample is poured into the viscosity testing while holding the stopper of the tester at mark. The sample should fill to the top of the cavity but should not overflow.

The stopper is removed. The time the sample takes to reach the end of the 31 cm mark on the sliding gauge of the tester is measured. In one aspect, the timing is measured as follows: the stopwatch is started as the stopper is removed from the tester; the timer is stopped as the product reaches the 31 cm mark on the sliding gauge; time is recorded; at minute 4 the above test is repeated and results recorded; at minute 6 the test is repeated and results recorded; the average is taken of the three tests. In another aspect, the target average time for the mix viscosity test is approximately 4-10 seconds.

The process continues, by weighing 4 the isolate and mineral blends and preparing 6 the protein mix as follows:

Isolates having a 4-10 second viscosity are blended 6 with at least one thick viscosity isolate and neutral flavored isolate at approximately the following ratios:
Thin viscosity protein—20-60% of blend
Thick viscosity protein—20-60% of blend
Neutral flavored protein—5-20% of blend
   In one aspect, the neutral flavored protein is omitted from the blend if the composition is flavored by other means, such as topical application or injected flavors.

The product modifier ingredients are added 8 and the resulting blend is mixed 8 for a sufficient time to provide complete dispersion of all ingredients. In one aspect, a ribbon type mixer is used. In this aspect, the mixing time is approximately 20 minutes or less.

The completed blend is cooked 10 and expanded 10 in an extruder or cooker expander. The completed blend is supplied to the cooker expander along with processing water to promote the cooking process. The unit is set up to provide adequate temperature, retention time, and pressure to cook the proteins and produce a composition having a defined cell structure which takes measurable force to crush. In one aspect, typical temperature settings for this process are approximately 100° Fahrenheit at the start of the process and approximately 220° Fahrenheit at the end of the process. In another aspect, cooking time is approximately 1-5 minutes.

In addition to the cooking 10 of the proteins, sheer 10 is applied to the mix while it is under heat and pressure. In one aspect, the sheering elements in the cooker expander are set to promote mixing of the process water in dough formation and cell development in the cooking stage.

Expanded product exiting the cooker former is cut 12 to the specified length by a high-speed cutter. In one aspect, the composition is sized by a roller cutter. In another aspect, the composition is sized by a rotating blade.

The composition is then conveyed 14 to the drying process. In one embodiment, the expanded composition is conveyed 14 to the dryer by a belt conveyor, vibratory conveyance system or air conveyance system. In one aspect, drying 16 is done in bed, band, tower or fluid bed dryer. Drying 16 is accomplished in any type of drying mechanism that is capable of removing approximately 8-15% moisture from the expanded composition. In another aspect, the expanded composition is placed in a bed oven, single pass band oven, multi-pass band oven or fluidized bed dryer. Typically, the drying temperature is approximately 200-300° Fahrenheit. In one embodiment, the composition exiting the dryer is approximately 3% moisture and approximately 80-85% protein with zero net carbohydrates.

In other embodiments, the composition may be cooked 10, expanded 10 and cut 12 by methods relating to grain processing in the areas of direct expansion extrusion, gun puffing, tower puffing, half product puffing or fluidized bed expansion.

The finished composition or product may be stored 18 or packaged 18 once the method of production is complete.

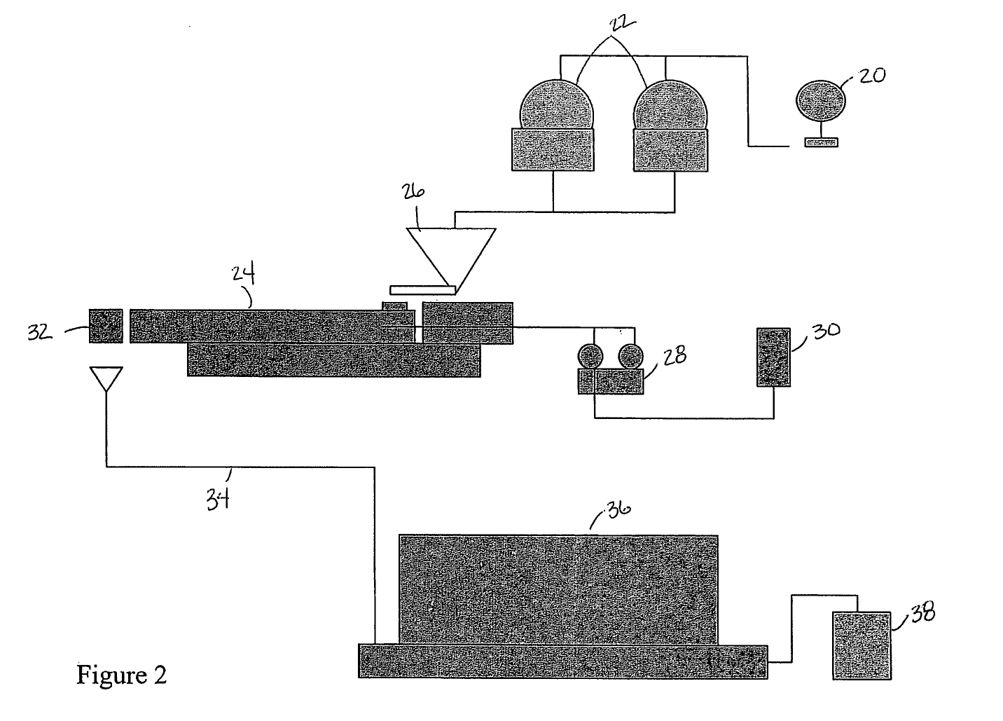

FIG. 2 is a schematic diagram of an apparatus for producing cereal product or food particulates with zero net glycemic carbohydrates and having defined cell structure and cell strength. After the viscosity has been tested (not shown), the isolates and minerals are prepared and weighed in a first container 20. In at least one mixing device 22, a protein blend is combined and mixed, wherein the protein blend comprises 20-60% thin viscosity protein isolate, 20-60% thick protein viscosity protein isolate, 5-40% neutral protein isolate, and at least one process aid or product modifier. The completed blend is then supplied to a cooking and expanding device 24 for cooking and expanding the protein blend. The completed blend is supplied via a dry blend metering feeder 26 to the cooking device 24 along with process water 30 to promote the cooking process. The cooking device 24 is controlled by metering pumps 28 to provide adequate temperature, retention time, and pressure to cook the proteins and produce a composition having a defined cell structure which takes measurable force to crush. In one aspect, the cooking and expanding device 24 contains sheering elements (not shown) to promote mixing of the process water in dough formation and cell development in the cooking stage. Expanded product exiting the cooking and expanding device 24 is then cut by a high-speed cutter 32. The composition is then conveyed by a conveyance system 34 to a dryer 36. The finished product may be stored in a storage bin 38 before packaging.

### EXAMPLE

The Invention is Further Described but not Limited by the Following Example:

A protein and product modifier mix with the following composition:

| | |
|---|---|
| Thin viscosity soy protein isolate | 65.0% |
| Thick viscosity soy protein isolate | 25.0% |
| Neutral flavored soy protein isolate | 5.0% |
| Calcium carbonate | 5.0% |
| Total | 100.0% |

The mix is added to the cooker former and cooking process water is added in the ratio of:

| | |
|---|---|
| Protein blend | 90.0% |
| Process water | 10.0% |
| Total | 100.0% |

Cook water, element speed and temperatures are adjusted to produce a composition exiting the cooker expander, exhibiting a bulk density of approximately 0.15-0.30 g/cc. After drying, the composition will have a bulk density of approximately 0.20-0.26 g/cc. Cell structure will be set and have a strength exhibiting a texture number above approximately 8 and typically between approximately 15 and 55 using a TA2 texture analyzer.

1. A method of producing a cereal product or food particulate with zero net glycemic carbohydrates and having defined cell structure and cell strength comprising:
preparing a protein blend by mixing 20-60% thin viscosity protein isolate, 20-60% thick protein viscosity protein isolate, 5-40% neutral protein isolate, and at least one process aid or product modifier;
cooking the protein blend;
expanding the protein blend;
cutting the protein blend; and
drying the protein blend.

2. The method of claim 1, wherein the thin viscosity protein isolate portion is soy isolate.

3. The method of claim 1, wherein the thick viscosity protein isolate portion is soy isolate.

4. The method of claim 1, wherein the neutral protein isolate portion is soy isolate.

5. The method of claim 1, wherein the combination of thin viscosity protein isolates, thick viscosity protein isolates and neutral protein isolates is approximately 90-100% of the protein blend.

6. The method of claim 1, wherein the process aid or product modifier is approximately 0-10% of the protein blend.

7. The method of claim 1, wherein the at least one process aid or product modifier is added to the protein blend to adjust pH.

8. The method of claim 1, wherein the at least one process aid or product modifier is added to the protein blend to adjust dough conditioning.

9. The method of claim 1, wherein the at least one process aid or product modifier is added to the protein blend to adjust leavening.

10. The method of claim 1, wherein the at least one process aid or product modifier is added to the protein blend to adjust cook retention.

11. The method of claim 1, wherein the cereal product or food particulate has a bulk density of approximately 0.5-0.30 g/cc.

12. The method of claim 1, wherein the cereal product or food particulate has a cell strength of approximately 11-55 measured by a Texture Technologies TA2 texture analyzer.

13. The method of claim 1, wherein the process aid or product modifier is selected from a group consisting of calcium carbonate, dicalcium phosphate, sodium bicarbonate, trisodium phosphate, fibers or mixtures thereof.

14. The method of claim 1, wherein the thin viscosity protein has a viscosity of approximately 4-10 seconds.

15. The method of claim 1, wherein the size of the cereal product or food particulates may be customized.

16. The method of claim 1, wherein the shape of the cereal product or food particulates may be customized.

17. The method of claim 1, wherein the flavor of the cereal product or food particulates is denoted by the absence “bitter bean” notes.

18. The method of claim 1, wherein the steps of cooking, expanding and cutting follow methods of grain processing in direct expansion extrusion.

19. The method of claim 1, wherein the steps of cooking, expanding and cutting follow methods of grain processing in gun puffing.

20. The method of claim 1, wherein the steps of cooking, expanding and cutting follow methods of grain processing in tower puffing.

21. The method of claim 1, wherein the steps of cooking, expanding and cutting follow methods of grain processing in half product puffing.

22. The method of claim 1, wherein the steps of cooking, expanding and cutting the protein blend follow methods of grain processing in fluidized bed expansion.

23. The method of claim 1, wherein cooking the protein blend is completed at temperatures of approximately 100-250° Fahrenheit.

24. The method of claim 1, wherein cutting the protein blend further comprises sizing the protein blend using a roller cutter.

25. The method of claim 1, wherein cutting the protein blend further comprises sizing the protein blend using a rotating blade.

26. The method of claim 1, wherein drying the protein blend further comprises drying the protein blend to a moisture below approximately 10%.

27. The method of claim 1, wherein drying the protein blend further comprises drying the protein blend to a moisture of approximately 3%.

28. The method of claim 1, wherein drying the protein blend further comprises conveying the protein blend to a dryer by a belt conveyor.

29. The method of claim 1, wherein drying the protein blend further comprises conveying the protein blend to a dryer by vibratory conveyance.

30. The method of claim 1, wherein drying the protein blend further comprises conveying the protein blend to a dryer by air conveyance.

31. The method of claim 1, wherein drying the protein blend further comprises drying the protein blend in a bed oven.

32. The method of claim 1, wherein drying the protein blend further comprises drying the protein blend in a single pass band oven.

33. The method of claim 1, wherein drying the protein blend further comprises drying the protein blend in a multi-pass band oven.

34. The method of claim 1, wherein drying the protein blend further comprises drying the protein blend in a fluidized bed dryer.

35. The method of claim 1, wherein the drying temperature is approximately 200-300 Fahrenheit.

36. An apparatus for producing cereal product or food particulates with zero net glycemic carbohydrates and having defined cell structure and cell strength comprising:
a mixing device for preparing a protein blend, wherein the protein blend comprises 20-60% thin viscosity protein isolate, 20-60% thick protein viscosity protein isolate, 5-40% neutral protein isolate, and at least one process aid or product modifier;
a cooking device for cooking the protein blend;
an expanding device for expanding the protein blend;
a cutting device for cutting the protein blend; and
a dryer for drying the protein blend.

37. A composition of cereal product or food particulates with zero net glycemic carbohydrates and having defined cell structure and cell strength comprising:
20-60% thin viscosity protein isolate;
20-60% thick protein viscosity protein isolate;
5-40% neutral protein isolate; and
at least one process aid or product modifier.

38. A composition of cereal product or food particulates with zero net glycemic carbohydrates and having defined cell structure and cell strength comprising:
20-60% thin viscosity protein isolate;
20-60% thick protein viscosity protein isolate;
5-40% neutral protein isolate; and
at least one process aid or product modifier,
wherein the 20-60% thin viscosity protein isolate, 20-60% thick protein viscosity protein isolate, 5-40% neutral protein isolate, and at least one process aid or product modifier is mixed, cooked, expanded, cut and dried.

39. A method of producing a cereal product or food particulate with zero net glycemic carbohydrates and having defined cell structure and cell strength comprising:
preparing a protein blend by mixing 20-60% thin viscosity protein isolate, 20-60% thick protein viscosity protein isolate, 5-40% neutral protein isolate, and at least one process aid or product modifier;
cooking the protein blend;
expanding the protein blend;
cutting the protein blend; and
drying the protein blend.

40. A method of producing a cereal product or food particulate with zero net glycemic carbohydrates and having defined cell structure and cell strength comprising:
cooking a protein blend having the approximate viscosity of a mixture of 20-60% thin viscosity protein isolate, 20-60% thick protein viscosity protein isolate, 5-40% neutral protein isolate, and at least one process aid or product modifier;
expanding the protein blend;
cutting the protein blend; and
drying the protein blend.

41. An apparatus for producing cereal product or food particulates with zero net glycemic carbohydrates and having defined cell structure and cell strength comprising:
a cooking device for cooking a protein blend, wherein the protein blend has the approximate viscosity of a mixture comprising 20-60% thin viscosity protein isolate, 20-60% thick protein viscosity protein isolate, 5-40% neutral protein isolate, and at least one process aid or product modifier;
an expanding device for expanding the protein blend;
a cutting device for cutting the protein blend; and
a dryer for drying the protein blend.

42. A composition of cereal product or food particulates with zero net glycemic carbohydrates and having defined cell structure and cell strength comprising:
a protein blend, wherein the protein blend has the approximate viscosity of a mixture comprising 20-60% thin viscosity protein isolate, 20-60% thick protein viscosity protein isolate, 5-40% neutral protein isolate, and at least one process aid or product modifier.

43. A composition of cereal product or food particulates with zero net glycemic carbohydrates and having defined cell structure and cell strength comprising:
a protein blend, wherein the protein blend has the approximate viscosity of a mixture comprising 20-60% thin viscosity protein isolate, 20-60% thick protein viscosity protein isolate, 5-40% neutral protein isolate, and at least one process aid or product modifier, and wherein the protein blend is mixed, cooked, expanded, cut and dried.
